(19) United States
(12) Patent Application Publication
(10) Pub. No.: US 2015/0262095 A1
(43) Pub. Date: Sep. 17, 2015

(54) Intelligent Decision Synchronization in Real Time for both Discrete and Continuous Process Industries

(71) Applicant: Bahwan CyberTek Private Limited, Chennai (IN)

(72) Inventors: Panchatcharam Rajasekaran, Chennai (IN); Balasubramanian Sivarama Krishnan, Chennai (IN)

(21) Appl. No.: 14/205,377

(22) Filed: Mar. 12, 2014

(51) Int. Cl. G06Q 10/06

(52) U.S. Cl. CPC G06Q 10/0635; G06Q 10/0637

(57) ABSTRACT

A composite technology system RETINA that enables intelligent decision synchronization in real time for continuous, discrete and batch process industries is disclosed. RETINA generates and synchronizes the intelligent decisions that affect the performance and profitability of business operations in real time and helps in analysis that are essential for any successful business operations in any manufacturing industries. RETINA combines the real time integration capability; Predictive analytics capability and adaptive real time process modeling capability to generate intelligent risk-reduced business decisions for continuous, discrete and batch manufacturing processes. RETINA unifies the data from disparate sources or in silos, collates, comprehends and analyses the data, and then convert them into actionable information in real time. Correct decisions are generated, streamlined and shared at the appropriate instant of time with right amount of data to the pertinent personnel to eliminate inefficiencies in operations and performance resulting in tangible profitability.

### FIELD OF THE INVENTION

The present invention relates to a dynamic, real time decision synchronization system more particularly to a real time risk—reduced intelligent business decision synchronization system that involves synchronization of operational data and business intelligence to generate risk-reduced business decisions for continuous, discrete and batch process industries. The invention integrates the shop floor and enterprise systems by collecting, validating, pre-processing data from multiple data sources in process industry and providing a framework that allows both manual and automatic multi parameter predictive model creation along with decision synchronization logic to enable intelligent business decisions. Further the invention uses artificial intelligence techniques, statistical methods, evolutionary algorithms and constraint optimization tools in tandem to process the data for decision generation and synchronization in real time.

### BACKGROUND

Availability of right amount of information and making timely decisions are imperative to realize high performance manufacturing business operations. Both continuous and discrete process industries operate under lots of constraints that are both system and human driven.

Upon detailed analysis, both continuous, discrete and batch process industries such as the oil and gas sector, power plants, cement plants, chemical plants, aluminum plants, copper plants, iron and steel plants, automotive assembly lines and pharmaceutical facilities are all devoid of intelligent decision synchronization mechanisms due to lack of integration of information between the operational and business line. Information is available in silos such as production systems, control systems, quality assurance systems besides the performance systems such as asset maintenance systems and the enterprise resource planning (ERP). The very presence of the silo of information and their lack of exchange amongst the operational and business systems leads to the loss of several critical and vital business advantages.

Currently there exist systems that offer only a combination of manual, semi-manual decisions to maximize business operation needs. While there are systems that offer real time integration, they don't provide modeling and analytics together. There are systems that provide modeling and analytics but these are not essentially real time capable. To add to this, another major capability that is lacking would be real time root cause analysis, diagnostics, forewarning and predictive capabilities though flexible real time data stream processing and modeling capabilities.

U.S. Pat. No. 7,584,165 by John Gibb Buchan discloses a real time support apparatus, method and system for facilitating decision making in an enterprise. It is used to make real time operations and maintenance decisions in connection with assets such as petroleum and petrochemical refinery. The real time process asset management apparatus uses Gensym G2 Expert system for Oil and Gas vertical and does not cover other process industries.

In US20130226317A1 by Vijayaraghavan et al., a real time computerized system is disclosed which is used to control, manage and optimize the machine tools by comparing the operational data with historical stored data. The data's are harvested and collected in a central data warehouse; the operational data is compared with the warehouse data by multi-variant analysis, etc to generate performance evaluation of the machines. The machines are mainly addressed for their environmental impacts, risk, maintenance, and safety. The real time computerized system does not reflect an integrated approach to operations excellence where it is essential to integrate the operation data with ERP and other business enterprise systems for unified decision making.

US8417360B2 by Sustaeta et al., discloses a control system and method for selecting, controlling and optimizing the machinery utilization and process performance. It also provides diagnostic and prognostic information about the process which can be integrated with the decision support systems, logistics systems and control systems to optimize specific operational performance of any process industry. However, this lacks any holistic view on overall unified performance improvement and better decision making integrated with business systems as well.

In US8311863B1 by Kemp, a high performance capability assessment model is disclosed. It relates to an efficient and cost effective way of identifying the performance of an organization. It helps to achieve a clear, consistent and well defined execution of core processes in utility industries with reduced inefficiencies and waste. This does not report on any real time decision making and support and further does not cover any other continuous or discrete process industries.

Absence of real time analytics hampers the ability of the business to take far fetching, game changing business decisions. Other Real Time Decision Manager that has predictive analytical decision making capability does not have real time raw data integration capability. Other Platform that has real time raw data integration capability does not have the capability for real time adaptive model driven analytical decision making. There exists a major void in generation and synchronization of decisions that will cause improvements to operations as a whole and improve profitability and responsiveness to potential opportunities and challenges, rather than isolated decision making. It was felt that real time integration and a risk reducing business decision support system, which sits on top of the integration platform, was necessary to enhance the business efficiency of the plant operations.

What is needed is a system and method which overcomes all the existing drawbacks by combining, real time data integration capability; Predictive analytics capability; adaptive real time process modeling capability; and capability to work for both continuous and discrete manufacturing processes to produce risk-reduced intelligent business decisions. What is further needed is a system and method which unifies the data from disparate sources, analyze and synchronize them with business system to generate risk-reduced intelligent business decisions wherein correct decisions are generated holistically and shared at the appropriate instant of time to the pertinent person and system to eliminate inefficiencies in operations and improve the process and production efficiency.

### SUMMARY OF THE INVENTION

In an aspect of the present invention, referred to herein as RETINA, a composite technology system for real time integration and synchronization of business and operation systems to enable intelligent risk-reduced business decisions for both discrete and continuous process industries is provided. RETINA combines the real time standard and non-standard data integration capability; Predictive analytics capability that is essential for successful business operations and adaptive real time process modeling capability to generate intelligent risk-reduced business decisions for continuous, discrete and batch manufacturing processes. RETINA starts its process by synchronizing, streamlining and consolidating data from several data sources including plant/shop floor. The synchronized data is subjected to plumbing and pre-processing techniques to create a wholesome actionable data. Finally the pre-processed data is modeled through heuristics, data oriented or statistical means to understand and establish the innate, inherent relationship that exists between the parameters in the data stream to provide a risk reduced decision. RETINA includes a data memory store which is used to store and manage the parameters and attributes from several data sources; data pre-processor used for pre-processing the data to create a wholesome actionable data; real-time logic processing and KPI computation engine which is the heart of the entire system and inside which the processing logic is built by the domain expert using the math power provided by Math Library block; RETINA interface management module is the data integration gateway of RETINA and can handle unlimited number of concurrent interfaces of similar or different types; internal archiving database which keeps track of configurations, variations, limits and other key attributes; math library tool kit with numerous computing libraries which is used by the domain expert to built the logic; modeler such as Fuzzy Logic modeler, Statistical regression fit modeler or neural network modeler to built the processing logic; constraint optimization algorithm for processing linear, non-linear programming models; KPI configuration module to dynamically configure the Key Performance Indicators that is to be computed by the Real Time Logic Processing and KPI Computation Engine; decision synchronizer to deliver intelligent risk-reduced decisions in a closed loop system; and finally a portal enabled dashboard to display a bird's eye view of the operations pertaining to a specific area configured by the domain expert.

The RETINA technology system is a versatile platform, which is diverse in utility value, application and usage across several process industries: continuous, discrete and batch such as oil and gas, power plants, cement, chemical, automotive, aluminum plants and pharmaceuticals facilities. RETINA is unique in enabling real time integration, diagnostics, decision support, prognostic and analytic dash boarding of Key Performance Indicator on demand. The entire decision generation and synchronization lifecycle is devised to be so simple that the user skills that are needed to use the system are limited to only basic computer operations and his domain knowledge. The system minimizes and removes any need or pre-requisite from the user to know the system programming or knowledge in using mathematical models.

In further aspects of the present invention RETINA is an all in one system that has data collaborative capability; artificial intelligence enabled heuristic and data modeling capabilities; an extensible software architecture that enables embedding evolutionary algorithms and constraint optimization toolkits; architecture scalability in an SOA driven model that allows easy integration of multiple systems across different technologies; an architecture that allows co-existence and seamless integration with business systems in a scalable manner; and finally it is a singular system for continuous, discrete and batch manufacturing environments in providing adaptive decision system minimizing or eliminating human intervention.

### BRIEF DESCRIPTION OF THE DRAWINGS

FIG. 1 illustrates the distinctive nature of RETINA incorporating various aspects such as real time dynamic predictive analytics;

FIG. 2 illustrates the architecture and building blocks of the RETINA;

FIG. 3 is a flow diagram representing the decision synchronization flow in RETINA;

FIG. 4 shows the decision synchronization of RETINA for cement manufacturing process;

FIG. 5 shows the decision synchronization of RETINA for oil and gas upstream process;

FIG. 6 shows the decision synchronization of RETINA for power generation;

FIG. 7 shows the decision synchronization of RETINA for aluminium extrusion process;

FIG. 8 shows the decision synchronization of RETINA for automotive manufacturing process.

### DETAILED DESCRIPTION OF THE INVENTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in detail so as to not unnecessarily obscure aspects of the embodiments of the invention. Furthermore, it will be clear that the invention is not limited to these embodiments only. Numerous modifications, changes, variations, substitutions and equivalents will be apparent to those skilled in the art, without parting from the spirit and scope of the invention.

Broadly, RETINA, a composite technology system, combines real time standard and non-standard data integration capabilities; a predictive analytics capability that is essential for successful business operations and an adaptive real time process modeling capability to generate intelligent risk-reduced business decisions for both continuous and discrete manufacturing processes. RETINA may be implemented

When in operation, the first step is to synchronize, streamline and consolidate data from several data sources including plant/shop floor which may be from a machine, equipment or a process area, from a plant control system, from an operations execution system or from a quality control system. The synchronized data is further subjected to plumbing and pre-processing techniques to create a wholesome actionable data. Finally the pre-processed data is modeled through heuristics, data oriented or statistical means to understand and establish the innate, inherent relationship that exists underneath the parameters in the data stream.

The RETINA technology system is a generic versatile platform, which is diverse in utility value, application and usage across several process industries: continuous, discrete and batch such as Oil and Gas, Power plants, Cement, Chemical, Automotive, Aluminium plants and pharmaceuticals industries. RETINA is unique in enabling real time integration, diagnostics, decision support, prognostic and analytic dash boarding of Key Performance Indicator on demand.

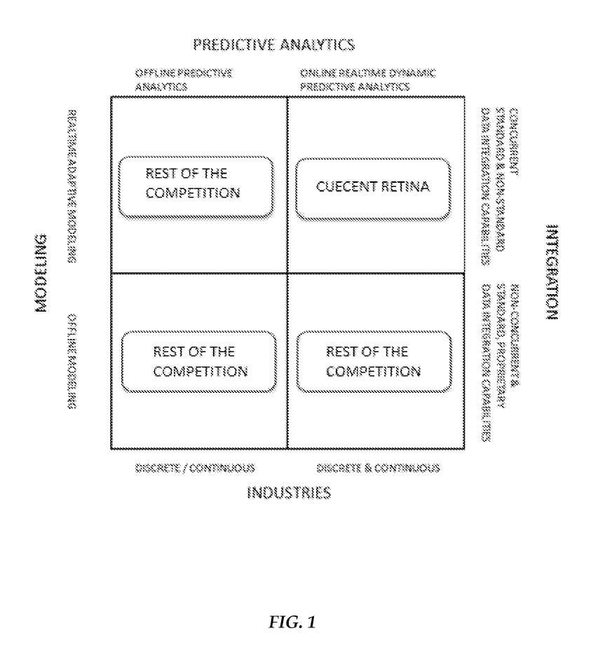

Referring now to FIG. 1, FIG. 1 shows the distinctiveness of the RETINA which includes:
(a) Integration: RETINA provides an adaptive and seamless platform that enables data integration and collaboration of real time, persistent, pseudo real time and non-standard data sources such as plant control systems: SCADA, DCS, PLC, Historians, Energy Meters, Machines, Field Equipment, CNCs, Lab equipment, MES, Hand Held devices, GIS systems, ERP, EAM, BI systems and Corporate Performance Management Systems. It has in-built adapters and data integrators to acquire data from above mentioned sources regardless of the nature of the process. RETINA can be configured to identify raw process parameters, derived parameters, manual feed and decision parameters. The acquired data are integrated with business systems such as Enterprise Service Bus systems, SOA enabled systems and Business Process Management Systems.
(b) Predictive Analysis: RETINA has provisions for online real-time predictive analytics wherein a framework for manual and automatic multi parameter predictive models are created.
(c) Modeling: RETINA has the capability to adjust, adapt, create and manage heuristic and data models and has provisions to select the model that is to be used during a particular scenario. The framework created can contextualize the data and information, devise models automatically and self-adjust them according to the scenarios.
(d) Industries: RETINA may be adapted to any type of process industry—continuous, discrete or batch.

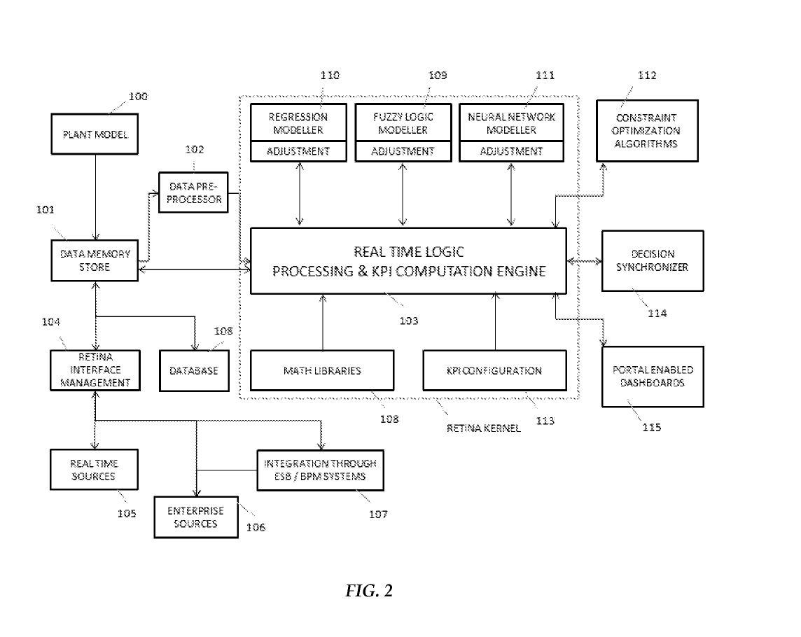

FIG. 2 shows the architecture and building blocks of an embodiment of the present invention. The Plant model (100) is a specific section, area or geography of the manufacturing facility where the present invention RETINA is configured. Data Memory Store (101) stores and manages the parameters and attributes from several data sources including plant/shop floor which may be from a machine, equipment or a process area, from a plant control system, from an operations execution system or from a quality control system etc. This data store memory is the mainstay to the real-time dynamic nature of RETINA, as it feeds the values continuously to the data pre-processor system (102) and then to the RETINA's Real-time Logic Processing and KPI computation engine (103). RETINA Interface Management module (104) is the data integration gateway of RETINA and can handle unlimited number of concurrent interfaces of similar or different types. RETINA Interface Management module (104) includes three types of interface management systems namely Real time source (105), Enterprise sources (106) and Integration through ESB/BPM systems (107). Real time source (105) is the assortment of real time interfaces of RETINA. Enterprise sources (106) represent the assortment of interface adaptors of RETINA that can connect with Enterprise Systems. Integration system (107) represents data connectivity between RETINA and other systems in IT landscape of an organization. RETINA can interface with enterprise systems either directly or through ESB/BPM systems. Database (108) is the internal archiving database of RETINA that keeps track of configurations, variations, limits and other key attributes and parameters of RETINA. Real Time Logic processing and KPI Computation Engine (103) is the heart of the entire RETINA system and the processing logic is built by the domain expert as IF-THEN or IF-THEN-ELSE formats using all the needed math power provided by Math Library block (108). Domain expert can use any of the following modeler to built the processing logic: Heuristic modeling of the engine or Heuristic modeling using Fuzzy Logic (109) and data modeling blocks of Statistical regression modeler (110) and neural network modeler (111). Constraint optimization algorithm (112) is used for processing linear, non-linear programming models using constraint optimization methodologies. The KPI configuration module (113) is used to dynamically configure the Key Performance Indicators (KPIs) that is to be computed by the Real Time Logic Processing and KPI Computation Engine (103). The Decision Synchronizer module (114) delivers the decisions, messages, reports, data in the form of action, triggers, events, e-mail alerts, SMS etc. The Portal Enabled Dashboards (115) displays a bird's eye view of the operations pertaining to a specific area which is configured by the domain expert as a role-wise dashboard portal.

In a preferred embodiment the data memory store (101) stores and manages parameters in the form of string, byte, bit, integer, long, double, float, including but not limited to the values, alarm limits, messages associated with limits etc.

In a preferred embodiment the data pre-processing module (102) uses mechanisms such as K-means clustering, Euclidian distance and Mahalanobis Distance, Z-score normalization and statistical outlier based data cleaning and plumbing mechanism to pre-process the data.

In a preferred embodiment the Interface management module (104) enables variety of integration capabilities including sources that are Real Time, Pseudo Real time, Manual Data, MES, Interfaces to ERP, Asset Management Systems, BI Systems, MIS systems, Laboratory equipment, Hand held devices and other systems that are SOA-enabled or connectable through ESB or BPM mode. Standard connectivity adaptors using published communication protocols such as OPC, COM, CORBA, XML, B2MML, WITSML, EDI, PRODML, Web services, MODBUS, DDE, ODBC, JDBC, OLEDB etc. as well as non-standard interfaces are supported.

In a preferred embodiment the real time sources (105) includes PLC, DCS, SCADA, HISTORIAN data sources that have the capability to share the data in standard modes or non-standard modes as mentioned in RETINA Interface Management module (104).

In a preferred embodiment the Enterprise sources (106) represent the assortment of interface adaptors of RETINA that can connect with Enterprise Systems such as Asset Management systems including IBM Maximo, SAP PM and Oracle PM, Enterprise Resource Planning Systems (ERP) systems such as Oracle EBS, SAP ECC 6.0 or R/3 using XML based data connectivity or Web Services or through data staging mechanisms.

In a preferred embodiment the Integration system (107) connects the data between RETINA and other systems in IT landscape of an organization which could be a legacy system or a billing system using SOA principles and connected through an ESB or a BPM layer.

In the preferred embodiment the Math Library (108) tool kit includes numerous computing libraries such as simple math, trigonometric, algebraic and statistical computations which can be pulled into the logic built by the domain expert.

In a preferred embodiment the Fuzzy logic (109) modeler constitutes the heuristic modeling capability of RETINA. RETINA implements Mamdani and TSK type of Fuzzy Logic controllers, there can be any number of Fuzzy logic controllers that can run in parallel. The model changes are sensed when predicted results of the fuzzy logic controller deviate from expected results by a critical value. The typical adjustments that would be done to the fuzzy logic controllers would be the membership ranges as well as the parameter ranges. The ranges are altered as a function of deviations encountered.

In a preferred embodiment the Statistical regression fit modeler (110) performs one to one or many to one regression fit. The models are built on the fly and they are altered based on Mean Integrated Squared Error (MISE) criterion set while configuring the model. The modeler produces the equations that relate parameters and these can be used directly in the Real Time Logic Processing and KPI Computation Engine (103). Therefore, whenever the modeler alters the equations, the same altered equation gets called dynamically in the logic execution engine without a need to alter the logic.

In a preferred embodiment RETINA provides both supervised and unsupervised neural network models (111). For supervised networks, back propagation algorithms that work with Generalized Delta Rules and Gradient Descent methods combined with Least Mean squared algorithms are implemented. Data pre-processing and Principle Component Analysis (PCA) applicable for neural networks are in-built in RETINA. PCA helps in reducing the dimensionality of the data and providing a clear set of parameters for modeling.

In a preferred embodiment the constraint optimization methodology (112) includes quadrating programming and dynamic programming algorithms with constraint equations being made easy and with objective functions. The data flows into the constraint model (112) from the Real time logic processing and KPI computation engine (103) dynamically. Any number of concurrent constraint models can be configured and made to run in the RETINA system.

In a preferred embodiment the domain expert uses general KPIs such as MTBF, MTTR, Specific Power Consumption, Specific Energy Consumption, Yield, Emission, OEE, Productivity etc. which are available pre-built in the system for dynamic configuration.

In a preferred embodiment the output from decision synchronizer (114) module can be closed loop with systems or connected, to alarm displays to correct personnel for manual action. The module also tracks the actions taken by the respective personnel on the decisions conveyed by the RETINA system and updates the same back to RETINA for a closed loop adjustment of the decisions and their impact.

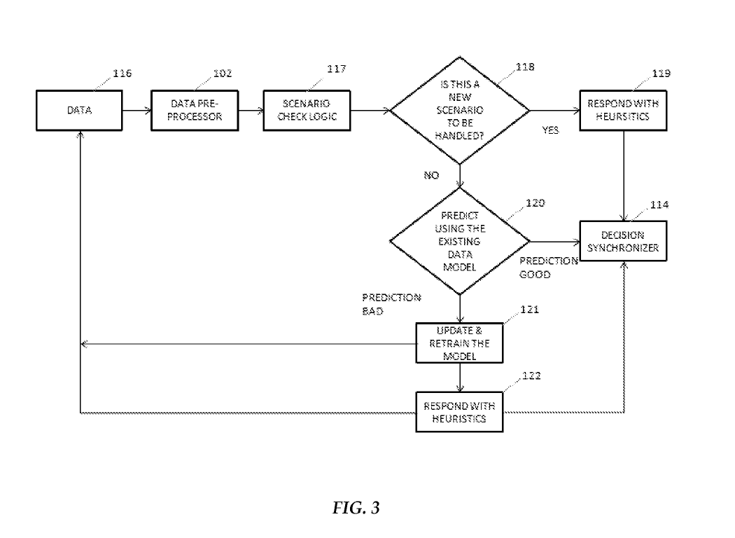

FIG. 3 depicts a flow chart showing decision synchronization flow in RETINA. RETINA makes a decision using the following sequential steps. First the data (116) flows into RETINA from data memory store (101) and then into data pre-processor (102) to get an actionable data. Scenario Check logic (117) is the logic that is built in the RETINA system as executed by Real Time Logic Processing and KPI Computation Engine (103). New scenario (118) block determines whether the scenario identified is a new scenario or already configured one based on the set of statements installed in the scenario logic box. In case of new scenario the system is executed by Heuristics (119) and in case if the scenario is already modeled, then the system is predicted using the existing data model (120). If the prediction is good as per the expected set of results, then the decisions are forwarded to the decision synchronizer (114) for decision delivery. If the prediction is bad as per the expected set of results, then the model needs to be updated and re-adjusted for usage (121). The model can be data based models such as Statistical regression (110) or neural network modeler (111). In the event of model requiring update, heuristics (122) is invoked for responding to the current scenario faced. This is done by configuring in the system the standard set of responses to the scenario that is to be handled by heuristics. Output of model that is tuned needs validation from the scenarios that arise so that the prediction can be depended upon for decision making.

In the preferred embodiment the modeling tool can be configured to have thresholds on limits of model accuracy. These thresholds determine if the model needs to be tuned or corrected or output to be used for decision making and management. These threshold values can also be dynamically computed using heuristic models to make the system adaptive.

RETINA eliminates the risks of inconsistent decision making in any process industry by providing a composite system with always on accuracy irrespective of the expertise or experience levels of personnel in business and operations.

In further embodiments present invention RETINA is an all in one system that has data collaborative capability; artificial intelligence enabled heuristic and data modeling capabilities; an extensible software architecture that enables embedding evolutionary algorithms and constraint optimization toolkits; architecture scalability in an SOA driven model that allows easy integration of multiple systems across different technologies; an architecture that allows co-existence and seamless integration with business systems in a scalable manner; and finally it is a singular system for both continuous and discrete manufacturing environments in providing adaptive decision system minimizing or eliminating human intervention.

### Example 1

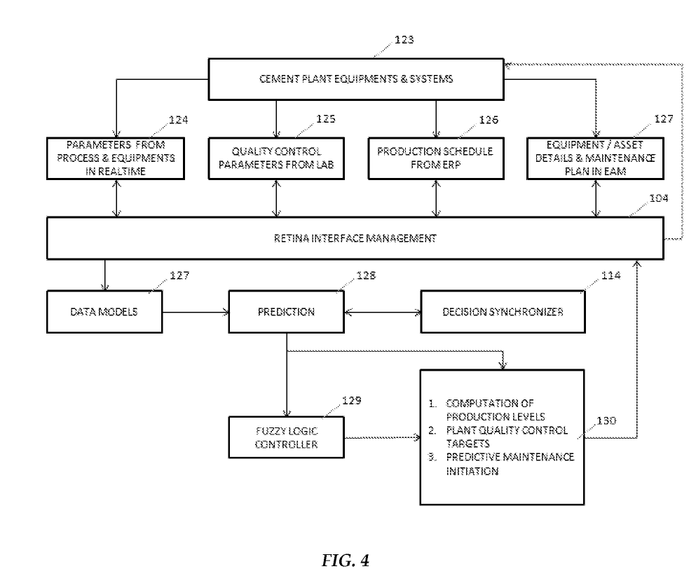

FIG. 4 shows the application of an exemplary embodiment of the present invention, namely a version of RETINA, to a cement manufacturing process. Cement plant (123) represent the cement manufacturing plant including its equipment and raw materials supplied from limestone mines all the way to cement packing. Plant parameters (124) come from a variety of sources such as process and equipment in real time, quality control from lab (125), production (126) from enterprise resource planning systems (ERP) and equipment details and maintenance plans in enterprise asset management systems (EAM) (127) is accessed by the RETINA interface management (104) for its decision synchronization. Data models (127) built to correlate between production parameters and quality parameters result in prediction (128), for example predicted outputs. The predicted outputs are passed to a decision synchronizer (114) to deliver appropriate intelligent decisions. The prediction (128) results are used by fuzzy logic controller (129) to deliver as a closed loop control. The prediction of outputs in real-time is done by a modeler of RETINA and will be executed by a real time logic processing and key performance indicator (KPI) computation engine (103). The desired production levels and type of cement need to be produced are understood by RETINA and the understanding is translated into actual maintenance of production and product manufacturing (130).

Preferably, the process parameters in real time (124) include grinding and gyro process parameters available in DCS, PLC, SCADA systems. Further, preferably, the quality control parameters (125) from the laboratory includes both physical and chemical attributes of interim products such as raw meal, kiln feed and clinker as well as of final finished good viz., cement. The results of a cement X-ray analyzer and diffractometer may be integrated for real time quality control. Maintenance schedules and asset details (127) are preferably obtained from asset management systems.

For clinker production, a multivariate regression fit as well as a neural network model are built using kiln feed rate, kiln rotation speed, kiln power consumption and burning zone temperature with clinker liter weight and free lime as quality parameters.

For cement production, multivariate regression fit as well as a neural network model are built using clinker feed rate, gypsum feed rate, grinding pressure, mill differential pressure, classifier speed parameters with cement residue and blain as quality parameters. Quality parameters are typically not available in real time. They are often manually measured and these are available typically every 2 to 4 hours from a laboratory. The quality parameters indicate the maintenance of adequate production levels as well as mixing of correct proportion of raw materials to ensure correct chemical composition of the clinker and cement. Such quality parameters may thus be entered manually or automatically into RETINA as they are generated.

Preferably the RETINA interface to ERP (126) dictates what type, quality and quantity of cement to be produced at what point of time.

Preferably, quality related issues and decisions are synchronized to a quality team, process related findings and decisions are conveyed to process and production teams, while plant equipment maintenance related issues and decisions are messaged to mechanical, electrical and maintenance teams. Parameter consistency, sensor issues determined and other connectivity related issues are provided to instrumentation teams of the cement plant.

Preferably, intelligent operations are maintained not just by automating the production demand from sales, but also keeping a close watch on equipment conditions and maintenance aspects of assets. The predictive module of RETINA estimates whether critical equipment would be available or not for getting a product made out of the process path that runs the equipment. Thus predictive maintenance can be triggered in advance to upkeep the plant and make it available for production of desired product as and when needed. This adds to the dynamic business adaptability of the manufacturing plant.

The use of RETINA in a cement plant would thus maximize the production, improve asset availability, reduce quality fluctuations, reduce fuel and energy consumption and improve responsiveness to business goals.

### Example 2

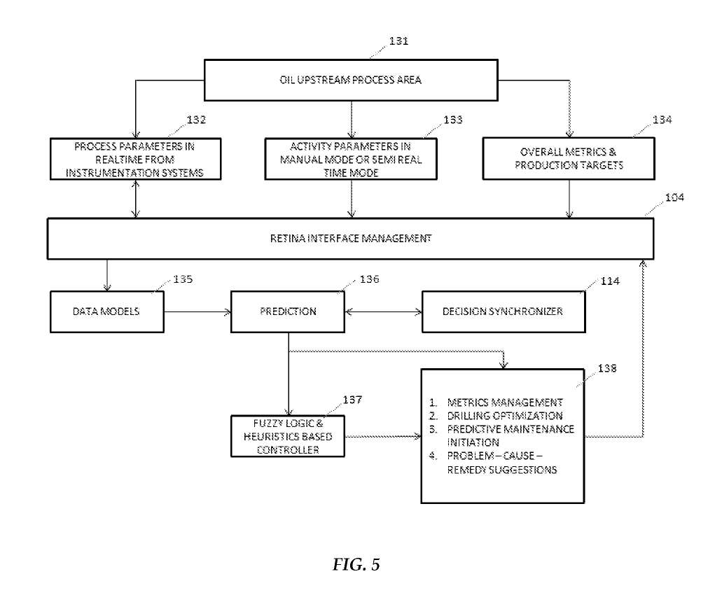

FIG. 5 shows the application of an embodiment of the present invention, namely a version of RETINA, to another continuous process industry—oil and gas upstream exploration processes. Oil or gas upstream process area (131) may be a well site area with drilling equipment trying to explore for oil or gas. RETINA interface management (104) interfaces with real time process parameters (132), activity parameters (133) and overall metrics (134) of the exploration process for decision synchronization (114). Data models (135) correlate the metrics needed with metrics available in real time. Prediction (136) yields results and decisions that are conveyed to the site in charge, drill supervisor, rig manager or other personnel regarding the state of drilling activity and what needs to be carried out to meet metric deadlines. The prediction (136) results are used by fuzzy logic controller (137) to deliver as closed loop control. The output of predicted results may be used for any closed loop actions on a drilling process, from drilling optimizations, or changing the drill bits or any other steps or actions typically associated with drilling processes.

Preferably, the drilling process parameters (132) in real time are taken from an instrumentation system of the drilling equipment in WITS (well site information transfer specification) formats. Also, preferably, the drilling activity parameters (133) that correlate directly with drilling process are entered in semi real time mode by drilling supervisors to account for every second of the activity. And, preferably, the overall targets and metrics needed for drilling activity are interfaced from a central ERP system or a specialized data mart.

In a preferred exemplary embodiment RETINA also enables predictive maintenance of drilling assets that is very critical to continue the drilling activities as well as synchronizing or triggering any asset purchase. The upstream drilling activities are asset intensive and any failures in assets could result in great loss of production in terms of time taken to get to reservoir usage for production. By computing Asset reliability and doing condition monitoring in real time, the present invention RETINA ensures sufficient pre-warning and remedial actions to be carried out for ensuring continuity in operations and prevent a complete halt in drilling activities.

Preferably, RETINA computes the metrics of drilling operations in real time and also guides the drill staff through the sequence in which operations are to be carried out so that the identified metrics are met. By virtue of data analytics and predictive capabilities, RETINA provides clear problem root cause analytics by which planners can view the drilling operations and plan the movement of equipment. Therefore, the use of RETINA in oil and gas upstream exploration process would improve drilling activity, Improve asset availability, minimize non-productive times, improved visibility of operations and reduce fuel and energy consumption.

### Example 3

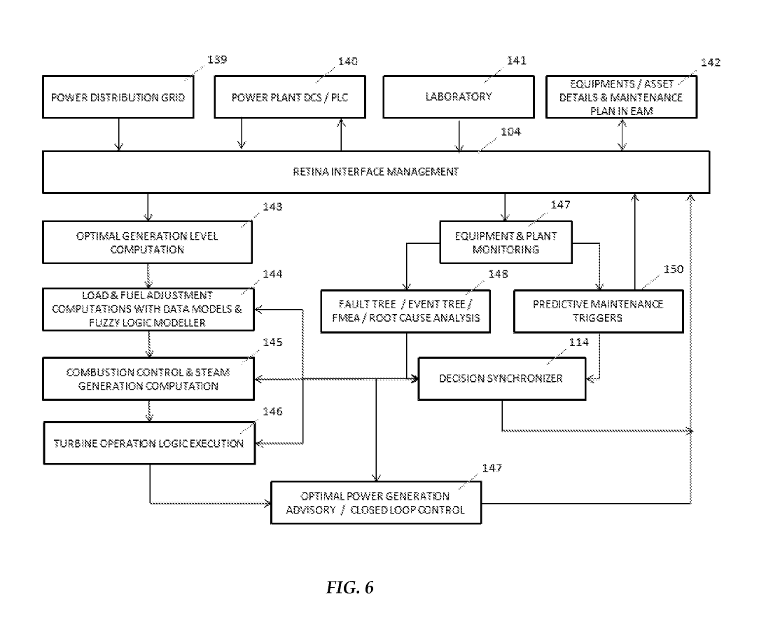

FIG. 6 shows the application of an embodiment of the present invention, namely a version of RETINA, to another continuous process industry, the power sector. The RETINA interface management module (104) acquires demand from the power distribution grid (139), real time process parameters from the power plant PLC/DCS (programmable logic controller/distributed control system) system (140), laboratory inputs (141) and asset related information from an asset management system (142). Optimal generation level computation (143) runs its constraint optimization module to determine the optimal generation target for the generator. Load and fuel adjustments (144) to the generator are done using a regression and fuzzy logic modeler. Combustion control and steam generation (145) is triggered to do a feed forward process response based on load settings. Turbine operation (146) is triggered to adjust to the new load settings. The combined effect of blocks 143, 144, 145 and 146 results in a synchronized, coordinated and integrated mechanism for optimal power generation that is either advisory or closed loop (147).

Preferably, the power generating utilities are connected to Power distribution grid (139). The transmission and distribution of power is determined by consumption, load and other major attributes such as the cost of energy. In such scenarios, the grid forecasts and lays out the demand for power that needs to be fulfilled by generating utilities.

Preferably, the power plant PLC/DCS system (140) provides access to real time process parameters such as temperature, pressure, flow, volume and other critical process parameters.

Preferably, the Laboratory analysis (141) provides the chemical and physical properties of fuel, water and emissions. These are critical to determine the efficiency of the power plant which determines how economical it is to operate the plant at various generation levels.

Preferably, the asset Management system (142) provides details of assets that are available in the power plants and provides details of their maintenance criticality.

Preferably, the computation for optimum generation target (143) for the generator is based on Demand at the point from the grid, Heat rate or efficiency levels of generation of the generator, Minimum and maximum load that the generator can handle at the given point of time and the Cost of Generation and economics of using the generator. The present invention RETINA runs its constraint optimization module to determine optimal generation levels from a multiple set of generators to meet the demand at any point of time from the grid. The computations are repeated if there is a change to the demand or any changes to availability of the generators or if there is any perceptible change to heat rate of the generator.

Preferably, embodiment the Load and fuel adjustments (144) uses fuel chemistry and load vs. efficiency characteristics as well as equipment limitations or constraints for determining the manner in which load can be altered.

By having access to process, quality data from the plant as well as data about the equipment from an asset management system, RETINA is able to engage in real time performance and condition monitoring of assets and equipment (147) in the power plant. Standard performance levels of the equipment under various ambient conditions are continuously compared with current operating levels to determine and sense any deviation in equipment conditions.

Equipment conditions monitored (147) by RETINA ensure that a thorough Fault Tree, Event Tree, FMEA and Alarm root cause analytics (148) to be enabled and carried out seamlessly to provide any pre-emptive decision making and synchronization (114).

Preferably, the predictive maintenance triggers (150) refrains in total the occurrence of any unwanted generation outage or any dangerous plant instability.

By providing an integrated management of power generation, embodiments of the present invention meet the required load demands in a cost effective manner, provide ideal targets for optimal combustion control, provide heat rate degradation computation and advisory information, provide alarm and fault root cause analytics, provide auto-pilot plant generation modes, and provide monitoring of equipment condition and predictive maintenance.

### Example 4

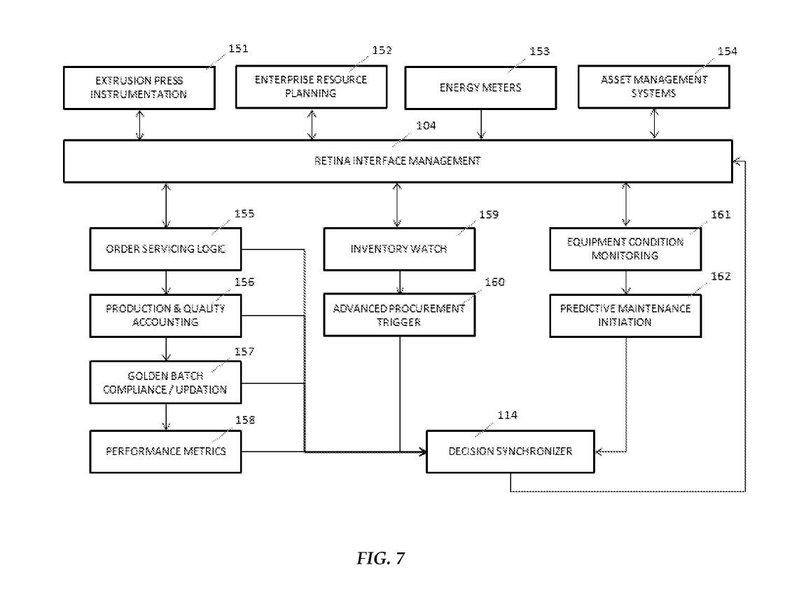

FIG. 7 shows the application of an embodiment of the present invention, namely a version of RETINA, for a discrete manufacturing industry such as minerals and metals in particular an aluminum extrusion process. RETINA interface management (104) module acquires and unifies information from different sources namely extrusion press instrumentation (151), enterprise resource planning (152), energy meters (153) and asset management system (154). Order servicing logic (155) configured in RETINA incorporates the priority of servicing the order. Once the servicing order is prioritized it becomes easier to do production and quality accounting (156), as well as monitoring the performance of each batch with respect to best performing batch or golden batch (157). Performance metrics (158) such as production rate, idle time, cycle time and down time along with OEE 9overall equipment effectiveness), MTBF (mean time between failures) and MTTR (mean time to recovery) are computed in real time. Inventory watch (159) monitors the consumption of inventory for extrusion and triggers any procurement or production of billets (160) considering the order service priorities and equipment availability forecasts. Real time monitoring of equipment is done by equipment condition monitoring module (161). RETINA triggers predictive maintenance triggers (162) based on equipment condition that is monitored by the equipment condition monitoring module (161). The decision synchronizer (114) module ensures triggers; decisions and actions are made at correct times and to correct levels of users.

Preferably, the extrusion press instrumentation (151) systems such as PLC and panels are used to acquire parameters such as die cast details, billet extrusion pressure, temperature, length of extrusion etc.

Preferably, the Enterprise Resource Planning (152) provides details on orders to be serviced as well as priority of servicing.

Preferably, the energy Meters (153) provides insights about the extent of energy consumption for extrusion activities.

Preferably, the asset management system (154) provides details of assets and their maintenance history and criticality. This can be a either integrated as a part of the Enterprise Resource Planning (152) or can be a separate standalone module.

Preferably, the order servicing logic (155) prioritizes the servicing order based on the constraints such as equipment availability that may be needed for specific orders and back logs in order servicing.

By virtue of the above functionalities, RETINA provides a highly integrated extrusion operation management that ensures effective order servicing, effective production and quality accounting, identification of idling and alerting, downtime analysis and improvement, inventory monitoring and pre-emptive triggers, and predictive maintenance.

### Example 5

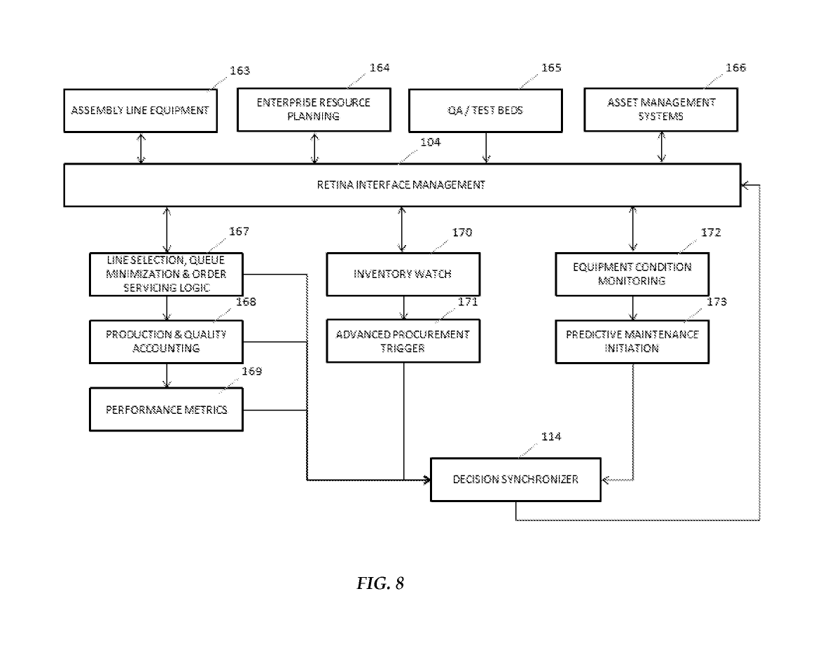

FIG. 8 shows the application of an embodiment of the present invention, namely a version of RETINA, for another discrete manufacturing industry such as automotive assembly lines. The manufacturing facility typically has multiple assembly lines to assemble the engines or automotive components or a full automotive itself. The RETINA interface management module (104) acquires and interacts with each of the data sources from assembly line equipment (163), enterprise resource planning (164), quality assurance and test beds (165) and an asset management system (166). Order service logic (167) manages the aspects of assembly line selection, queue minimization and idle time reduction. Production and quality accounting (168) manages the production and quality aspects for each stage in the assembly line as well as with respect to the whole manufacturing facility. Performance metrics (169) or KPIs (key performance indicators) are computed through RETINA KPI computation modules and also the maintenance related KPIs are computed in real time using the same module. Inventory watch (170) closely watches the inventory consumed for assembly at each stage as well as keeps track of any wastage. Based on the criticality of the consumption as well as on the rate of consumption and the orders to be serviced, RETINA issues a trigger for procurement (171) and stocking of components considering the lead times of their availability. Equipment condition monitoring (172) monitors the condition of equipment in assembly lines using their PLCs. The run hours and other important parameters that reflect the state of machinery are computed. Any abnormality in machinery and equipment conditions are captured as they occur and this enables the RETINA to send out predictive maintenance (173) notifications to the asset management system. The findings of assembly lines in terms of performance metrics, quality assurance (QA) results, and contribution of components to the QA of the assembly, triggers for inventory and triggers for predictive maintenance are sent across to the various stake holders in the manufacturing as well as to the assembly line by the decision synchronizer (114).

Preferably, the assembly line PLCs (163) capture parameters such as actual start time, torqueing parameters, state of the stage and other relevant data.

Preferably, the enterprise resource planning (164) provides details on orders to be serviced as well as priority of servicing.

Preferably, the stage wise QA or end of line QA test beds (165) provide details such as engine assembled, type of tests performed, results of the tests and time of tests.

Preferably, the asset management system (166) provides details of the assets and their maintenance history as well as criticality and other relevant data. This can be a either integrated as a part of the enterprise resource planning module (164) or can be a separate standalone module.

Preferably, the order service logic (167) manages the aspects of assembly line selection, queue minimization and idle time reduction based on several considerations such as previous line performance history, stage maintenance schedules, nature of orders to be serviced and other operation constraints. The constraint optimization module is used to select the line providing the constraints of production, based on idling, line availability and other relevant data.

Preferably, the production and quality accounting (168) manages the production and quality aspects using the following real time data such as raw material consumption, energy consumption, processing times, idle times, down times with regards to ANDONs (a system to notify management, maintenance, and other workers of a quality or process problem), QA details etc.

Preferably, the KPIs include production rate, rejection rate, component failures, reworks, top reasons for downtimes, and other ANDON parameters.

This holistic and integrated approach of RETINA enables manufacturing to achieve operations excellence by the way of achieving, effective order servicing; production and quality accounting; stage idling/clogging detection and forecasting; QA stage monitoring and defective component identification; inventory monitoring and pre-emptive triggers; and predictive Maintenance.

### Ramification

As shown and described herein, RETINA eliminates the risks of inconsistent decision making in continuous, discrete and batch process industries by providing a composite system with always on accuracy irrespective of the expertise or experience levels of personnel in business and operations. Experienced operators in continuous and discrete process industries operate the plants in a near optimal manner to provide best possible throughput in a constraint driven environment, however production throughput and yield are inconsistent due to anomalies in human decision making process. Thus the advantages of RETINA are readily apparent:
(a) RETINA acts as an all in one system that has data collaborative capability.
(b) RETINA provides artificial intelligence enabled heuristic and data modeling capabilities.
(c) RETINA has an extensible software architecture that enables embedding evolutionary algorithms and constraint optimization toolkits.
(d) RETINA enables architecture scalability in an SOA driven model that allows easy integration of multiple systems across different technologies.
(e) RETINA acts as a singular system for continuous, discrete and batch manufacturing environments in providing adaptive decision system minimizing or eliminating human intervention.
(f) RETINA provides an architecture that allows co-existence and seamless integration with business systems in a scalable manner.

The embodiments of the present invention may be implemented using any appropriate computer system hardware and/or computer system software and network connections or wireless or wired networks in communication or residing upon the relevant industrial facility network(s) or equipment. In this regard, those of ordinary skill in the art are well versed in the type of computer hardware that may be used (e.g. personal computers, networks, servers, and client devices), the type of programming techniques that may be used (e.g. object oriented programming), the types of computer languages that may be used. For example, enterprise resource planning systems in communication with embodiments of the present invention may include IBM Maximo™, SAP PM™, Oracle PM™, Oracle EBS™ SAP ECC 6.0™ or R/3™ using XML based data connectivity or web services.

It will be understood that the invention described herein can be performed in any order and can be performed once or repeatedly. Various operations described herein may be implemented in hardware, software, and/or any combination thereof. It is to be understood by the person skilled in the art that the examples and illustrations in figures describe the invention in the best possible way and are not limiting the scope of the invention.

1. A composite technology system, that combines the real time standard and non-standard data integration capability, predictive analytics capability, adaptive real time process modeling capability, and capability to work in continuous, discrete and batch manufacturing processes to produce risk-reduced intelligent business decisions, comprising:
a. data memory store to store and manage parameters and attributes from a plurality of data sources;
b. a data pre-processor to pre-process the data;
c. a real-time logic processing and key performance indicator computation engine having a processing logic built by a domain expert using math power provided by a math library block;
d. an interface management module having a data integration gateway to handle a plurality of concurrent interfaces of similar or different types;
e. an internal archiving database which serves to keep track of configurations, variations, limits and key attributes;
f. a math library tool kit having a plurality of computing libraries wherein said math library tool kit is used by a domain expert to build logic;
g. one or more of a heuristic and data based modeler embedded in the real time logic processing and key performance indicator computation engine which builds a processing logic;
h. a constraint optimization algorithm for processing linear and non-linear programming models;
i. a key performance indicator configuration module to dynamically configure key performance indicators that computed by the real-time logic processing and key performance indicator computation engine;
j. a decision synchronizer to deliver intelligent risk-reduced decisions in a closed loop system; and
k. a portal enabled dashboard to display operations pertaining to an area configured by the domain expert.

2. The composite technology system as claimed in claim 1, wherein the parameters stored in data memory store are from one or more of a machine, equipment, process area, plant control system, operations execution system or quality control system.

3. The composite technology system as claimed in claim 1, wherein the data pre-processing is accomplished using one or more of K-means clustering, Euclidian distance and Mahalanobis Distance, Z-score normalization and statistical outlier based data cleaning and plumbing mechanisms.

4. The composite technology system as claimed in claim 1, wherein the interface management module comprises three types of interface management systems:
a. a real time source which comprises one or more real time interfaces consisting of a programmable logic controller, a distributed control system, a supervisory control and data acquisition system, and historian data sources;
b. an enterprise source comprising interface adaptors in communication with one or more enterprise systems consisting of (i) asset management systems and (ii) enterprise resource planning systems; and
c. an integration system capable of connecting data with other systems in an information technology landscape of an organization using service oriented architecture and connected through an enterprise service bus or a business process management layer.

5. The composite technology system as claimed in claim 1, wherein the math library tool kit comprises one or more computing libraries comprising one or more of simple math, trigonometric, algebraic and statistical computation libraries.

6. The composite technology system as claimed in claim 1, wherein the modeler is selected from the group consisting of a fuzzy logic modeler with heuristic modeling capability; a statistical regression fit modeler which performs one to one or many to one regression fit, and a neural network modeler with supervised and unsupervised networks.

7. The composite technology system as claimed in claim 1, wherein the constraint optimization algorithm is one or more of a quadrating programming and a dynamic programming algorithm.

8. The composite technology system as claimed in claim 1, wherein the key performance indicator comprises mean time between failures, mean time to recovery, specific power consumption, specific energy consumption, yield, emission, overall equipment effectiveness and productivity.

9. The composite technology system as claimed in claim 1, wherein the decision synchronizer delivers one or more of decisions, messages, reports, and data in the form of one or more of actions, triggers, events, e-mails, and short message service messages.

10. The composite technology system as claimed in claim 1, further comprising an online real-time predictive analytics module for creating manual and automatic multi parameter predictive models.

11. The composite technology system as claimed in claim 1, wherein the system provides real-time integration between business and operations systems.

12. The composite technology system as claimed in claim 1, wherein the system is deployed in one or more of continuous, batch and discrete processing industries.

13. The composite technology system as claimed in claim 12 where continuous, batch and discrete processing industries are selected from the group consisting of oil and gas, power, cement, chemical, automotive, aluminum, and pharmaceutical plants.

14. The composite technology system as claimed in claim 1, wherein the system has a decision synchronizer that allows flexibility for operators, planners and business decision makers in making business decisions that provide overall excellence in operations.
